(19) United States
(12) Patent Application Publication
(10) Pub. No.: US 2024/0151340 A1
(43) Pub. Date: May 9, 2024

(54) Hydrogen-Ready Closure Door for Pipeline Use

(71) Applicant: TDW Delaware, Inc., Wilmington, DE (US)

(72) Inventors: Roger L. Poe, Beggs, OK (US); Jon Maslen, Sand Springs, OK (US); Kolton Landreth, Jenks, OK (US); Jed Hightower, Sapulpa, OK (US)

(21) Appl. No.: 18/497,520

(22) Filed: Oct. 30, 2023

Related U.S. Application Data
(60) Provisional application No. 63/381,493, filed on Oct. 28, 2022.

(51) Int. Cl. F16L 55/115; F16J 13/06

(52) U.S. Cl. CPC F16L 55/1152; F16J 13/06

(57) ABSTRACT

A closure for pipelines carrying a fluid under pressure, the closure includes at one or more seals located on a vertical sealing face of the barrel collar along a leak pathway between a horizontal sealing face of the barrel collar and an ambient environment. In some embodiments, the horizontal sealing face includes a primary seal. The one or more seals are adapted to prevent the escape of fluids having a lower molecular weight than that of the main pipeline product or fluid contained by the closure, and is arranged to alter a path of a leak pathway to the ambient environment and to cause at a pressure drop across the one or more seals. The closure may also include a leak check valve for blowdown.

### CROSS-REFERENCE TO RELATED CASES

This application claims the benefit of U.S. provisional patent application Ser. No. 63/381,493, filed on Oct. 28, 2022 and incorporated herein by reference.

### BACKGROUND

This disclosure is in the field of pipeline closures, including but not limited to closures suitable for use with diatomic hydrogen and other small-molecule fluids.

Closure applications include providing safe access to pig traps, filters, strainers, scrubbers, heat exchangers, and other vessels. By way of example, one of the most critical operations in pigging is opening a closure that provides access to a pig trap during launch and recovery operations. When the closure door is opened for the insertion or removal of a pig or other tool, there is a risk of explosive gas-air mixture.

An example closure is T. D. Williamson's D2000™ closure. After depressurization, opening and closing operations are performed in a single motion, with the operator standing safely to one side. Opening and closing of the closure may be done with a handle, as is typical of closures in a range of 30 inches or less, or with a side screw, as is typical for closures 32 inches and above (and optional with closures in a range of 24 to 30 inches). A pressure warning lock, in accordance with UG-35 of ASME Sect. VIII, Div. 1, alerts the operator to the existence of internal pressure prior to opening the closure. A single large cross-sectional diameter O-ring located on the periphery (horizontal sealing face) of the closure's barrel collar provides positive sealing as well as protection from damage by tools, pigs or debris.

There has been a shift in the pipeline industry, particularly in Europe, where hydrogen is being mixed or blended with methane to lower greenhouse gas emissions. Where pipelines may have previously transported mostly natural gas, carbon dioxide, ammonia, petroleum liquids, and water, some are now transporting hydrogen blended with natural gas. A typical blend is about 5% to 10% hydrogen, but efforts are underway to increase this to 30% and even to as much as 50%.

Hydrogen, with a molecular weight of 2.016, is one of the smallest molecules and, therefore, one of the hardest to contain. Because the hydrogen molecule is so small, it can easily permeate through certain metals as well as into and past a seal's lattice structure or polymers. This permeation causes the seal to expand. The hydrogen can cause the seal to crack or bubble, creating leak paths through the seal. In some cases, the seal can catastrophically explode as high operation pressures are blown down to ambient pressures during operation to load and unload pigs.

Because of hydrogen's ability to move through seals and even metals, a need exists for a closure design, sealing system, and a method specific for hydrogen-based fuel blends to keep the area around the closure free of ignition hazards and free of inventory loss. Even a small crack of about 1/16″ (1.6 mm), in a 1500-psig (10.3 mpa) pipeline, can leak over $1 US million's worth of methane and hydrogen over the course of a year.

### SUMMARY

Embodiments this disclosure include one or more seals located on a vertical sealing face of a barrel collar that receives a door of a pipeline closure (the sealing face of the door being opposite that of the barrel collar). The one or more seals present a labyrinth, tortious, or non-linear path along a leak pathway between the barrel collar and the door, and provide a pressure drop. A check leak valve may be used in connection with the seals to bleed off a volume of fluid trapped by the seals. In some embodiments, the trapped fluid may be sent to a compressor and reinjected into the pipe contained by the closure. The fluid may be hydrogen or ammonia.

In some embodiments, the one or more seals are secondary seals located between a primary seal of the pipeline closure door and an ambient environment outside of the closure, the interior face of the closure door being exposed to pipeline pressure, the exterior face being exposed to the ambient environment. The primary seal is typically located on a horizontal sealing face of the barrel collar and is generally a larger diameter seal (e.g. ½ ″ to ¾ ″ or about 12.7 to 19 mm) than that of the secondary seal (another sealing face of the door being opposite that of the barrel collar). In other embodiments, there is no primary seal and the one or more secondary seals are on the barrel collar or the door. The seals may be located along a horizontal sealing face in addition to the vertical sealing face. The a portion of the closure door lies between the horizontal sealing face of the barrel collar and the clamp ring; the vertical sealing face lies adjacent a portion of the clamp rings.

The one or more seals, which may be located in a groove of the barrel collar that receives the door, alters a path of a leak pathway to any fluid escaping past the primary seal. The groove may be a dovetailed groove. Whether used alone as a primary seal, or used in combination with a primary seal, the one or more seals also creates a pressure drop. In embodiments, any fluid escaping the one or more seals is at a pressure below pipeline pressure, that is, the pressure being contained by the closure, and may be at ambient pressure. The one or more seals, unlike the primary seal, are not subjected to liquids, experience a different pressure, have a different mounting as well as a different compression ratio and rate than that of the primary seal. The one or more seals may also vary in number.

In other embodiments, the closure comprises a door; a barrel collar, the barrel collar including a primary seal adapted to seal the barrel collar against the door; at least one clamp ring adapted to capture a circumferential portion of the door and the barrel collar when in a clamped state. The at least one secondary seal is located along a leak pathway between the primary seal and an ambient environment outside of the closure, with the at least one secondary seal adapted and arranged to alter the leak path and to cause a pressure drop. The one or more seals on the vertical sealing face of the barrel collar, or the primary seal on horizontal sealing face of the collar and the at least one secondary seal on the vertical sealing face of the collar, may be coaxial with the barrel collar.

In embodiments, the door may include one or more leak check valves arranged to evacuate any escaping fluid between the seals. In this way, the seals can be arranged for double block and bleed. The valve may be manually operated to bleed off the trapped fluid. The valve may be in communication with another existing valve or port of the door, such as but not limited to a pressure warning lock of the closure. In some embodiments, the trapped fluid is recompressed and reinjected into the pipe.

The one or more seals, when used in combination with a primary seal, may have a smaller cross-sectional diameter than the primary seal. The primary seal may lie in a different plane than any of the secondary seals. The one or more seals may be composed of a hydrogen reliable material (as may the primary seal). The seals may be of a higher durometer than that of the primary seal. In some embodiments, the secondary seals are hardened or filled with carbon black or its equivalent. As the molecular weight of the fluid to be prevented from escaping decreases, the durometer of the secondary seal should increase.

A method of this disclosure for reducing an escape of fluid through a pipeline closure includes arranging one or more seals along a vertical sealing face of the barrel collar or arranging one or more secondary seals along the face between a primary seal of the pipeline closure on the horizontal sealing face of the barrel collar and an ambient environment outside of the pipeline closure so that a leak pathway to the ambient environment is non-linear and a pressure drop occurs over the one or more secondary seals. In embodiments where the closure includes a primary seal, the method includes preventing an escape of a first fluid having a first molecular weight via the primary seal and preventing an escape of a second fluid having a second molecular weight lower than the first molecular weight via the one or more secondary seals.

In some embodiments, the method comprises evacuating, through a leak check valve, a volume of fluid residing between the primary seal and a secondary seal or between adjacent secondary seals. In other embodiments, the volume of fluid is recompressed and reinjected into the pipe. In yet other embodiments, a space between adjacent seals is pressurized at a pressure P2 greater than that of the pressure P1 contained by the closure.

### BRIEF DESCRIPTION OF THE DRAWINGS

FIG. 1 is a partial top cross-section view of a primary seal located between a closure door and a barrel collar on a horizontal sealing face between the collar and door. When in a clamped or sealed condition, the interior face of the closure door is exposed to pipeline pressure, the exterior face of the door is exposed to ambient pressure.

FIG. 2 is a partial top cross-section view of an embodiment of a closure of this disclosure.

FIG. 3 is a partial rear cross-section perspective view of an embodiment of a closure of this disclosure.

FIG. 4 is a partial top cross-section perspective view of the closure of FIG. 3.

FIG. 5 is a perspective view of the closure of FIG. 3 with the barrel collar exposed by the door.

FIG. 6 is a schematic illustrating a tortuous path comprising a series of O-Ring seals located along the vertical sealing face of the closure and differential pressure drops.

FIG. 7 is a schematic illustrating a tortuous path comprising a series of X-Ring seals located along the vertical sealing face and differential pressure drops.

FIG. 8A is a partial cross section perspective view of an embodiment of a closure of this disclosure with a vent valve.

FIG. 8B is a partial cross section perspective view of an embodiment of a closure of this disclosure with an inlet valve to pressurize the space between seals. This embodiment can be useful in applications where the closure door experiences a vacuum such as, but not limited to, pipeline fluid containing ammonia.

FIG. 8C is a partial cross section perspective view of an embodiment of a closure of this disclosure equipped to blow down.

FIG. 8D is a partial cross section perspective view of an embodiment of a closure of this disclosure equipped to recompress leaking pipeline product and reinject it back into the pipeline.

FIG. 9 is a cross sectional perspective detail of an embodiment of a closure of this disclosure with dovetail grooves on the vertical sealing face in which the seals reside. A leak valve may be included in the door to bleed off any fluid trapped between the seals.

Elements and numbering used in the drawings and detailed description are:
100 closure
102 barrel collar
103a horizontal sealing face (between collar and door)
103b vertical sealing face (between collar and door)
104 closure door
105 closure handle
106 weld bevel
108 clamp ring
110 primary seal system
112 seal along horizontal sealing face (O-ring or primary seal)
114 grooves
120 seal system along vertical sealing face (primary or secondary)
122 seal or impediment
130 vent valve
132 check valve
134 inlet valve
136 vapor barrier
138 pressure warning lock
200 leak pathway
202 differential pressure drop
622 O-ring secondary seal
722 X-ring secondary seal
900 ambient environment

### DETAILED DESCRIPTION

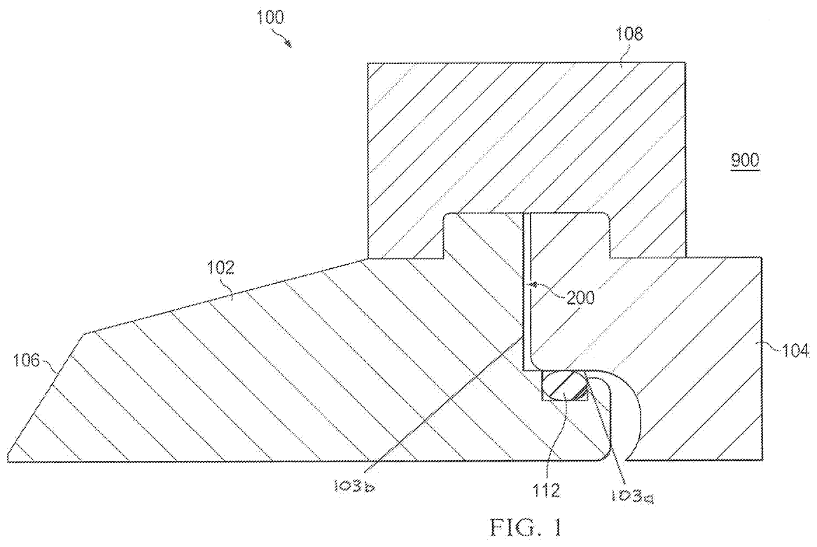

Referring now to FIG. 1, a partial top cross-section view of a primary seal 112 located between a closure door 104 and a barrel collar 102 along a horizontal sealing face 103a between the collar 102 and door 104 is shown. In some embodiments, the barrel collar 102 has a weld bevel 106 to enable a secure weld to a pipeline. The primary seal 112 may prevent fluid from escaping through a leak pathway 200 between the door 104 and the barrel collar 102. In embodiments, the fluid may include hydrogen. One or more clamp rings 108 may be adapted to capture a circumferential portion of the door 104 and the barrel collar 102 when in a clamped state. If the primary seal 112 blisters or fails, fluid or gas from inside the closure may easily leak into the ambient environment 900. FIG. 1 does not show a seal system 120 of this disclosure along a vertical sealing face 103b.

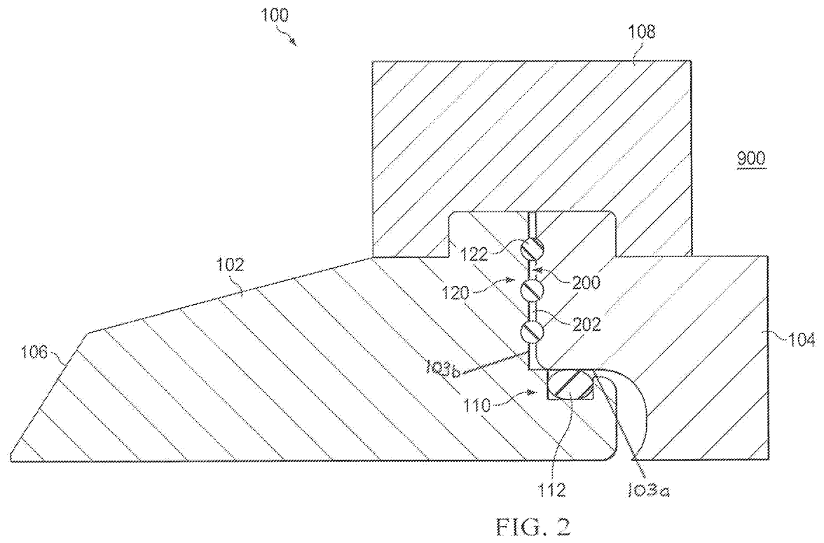

Referring now to FIG. 2, a partial top cross-section view of an embodiment of a closure 100 of this disclosure is shown. Like the embodiment of FIG. 1, the closure 100 may have a door 104, a barrel collar 102, a weld bevel 106, and at least one clamp ring 108. The closure may have a primary seal system 110 between the door 104 and the barrel collar 102. In the embodiment of FIG. 2, a seal system 120 may be located between the closure door 104 and the barrel collar 102, positioned on a vertical sealing face 103b between the door 104 and the barrel collar 104, along the leak pathway 200 from the primary seal 112 the ambient environment 900. The seal system 120 with at least one seal or impediment 122 may be located toward the sealing side of the door 104 and may provide a tortuous, non-linear leak path 200 for the hydrogen or other pipeline fluid to prevent its escape. Additionally, there may be a differential pressure 202 across each of the seals 122. Thus, the seal system 120 may present a labyrinth or tortuous leak pathway 200 as well as one or more differential pressure drops 202 that a gas must traverse in order to escape the closure. When used in combination with a primary seal 112, the seal system 120 is a secondary seal system. The seal system 120 may also be the primary seal system.

In embodiments, the seal system 120 can be made up of any device or impediment 122 suitable for sealing the vertical sealing surface or face 103b of the barrel collar 102 to the door 104 and for making a tortuous path 200 that the gas must travel to reach the ambient environment 900 and a differential pressure 202 on each side of the impediment 122 that the gas must overcome. Even if the primary seal 112 blisters or sustains other damage, the system 120 may present a tortuous path 200 and differential pressure 202.

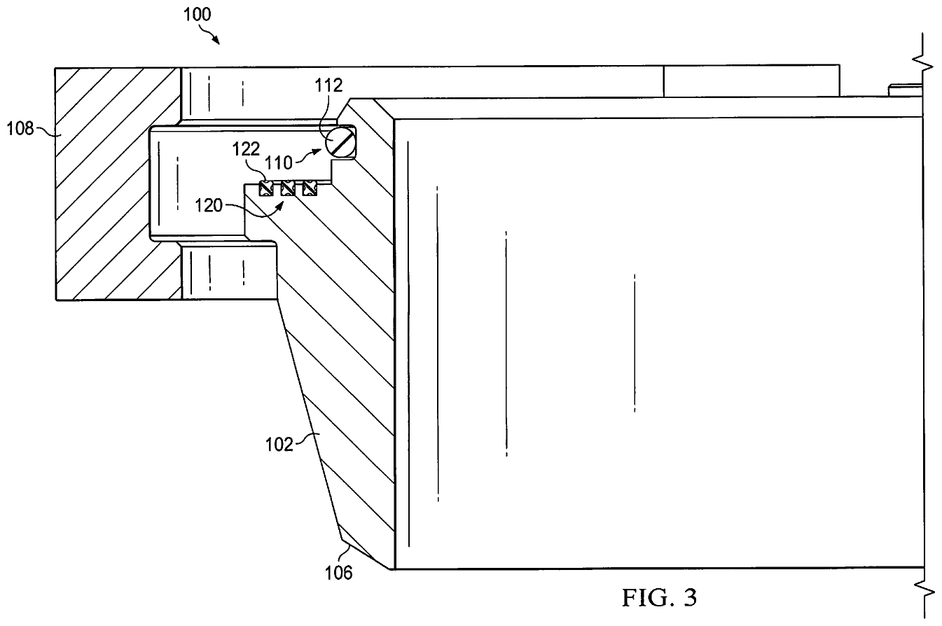

Referring now to FIG. 3, a partial rear cross-section perspective view of an embodiment of this disclosure is shown. In embodiments, the seals 112, 122 of the primary and secondary systems 110, 120 are circumferential seals arranged coaxial to the barrel collar 102. The seal of the primary system 112 may lie in a plane different than, and parallel to those, in which the seals of the secondary system 122 lie. The primary seal 112 may be spaced farther in the axial direction from the first seal of the secondary system 122 than is the spacing between the seals of the secondary system 122. The seal of the primary system 112 may be a larger diameter than those of the secondary system 122. The primary and secondary seals 112, 122 may have different hardness or be made of different materials.

Referring now to FIG. 4, a partial top cross-section perspective view of the closure of FIG. 3 is shown. In embodiments, the non-linear leak path 200 includes one or more seals 122 in the vertical sealing face 103b of the closure door 104 or on the barrel collar 102. The number of seals 122 that make up the path 200 can be a function of the fluid to be contained, the pipeline pressure, and the size of the closure door 104. The larger the closure door 104, the more seals 122 that can be applied. In some embodiments, the seal system 120 forms a tortuous enough leak path 200 to forgo the primary seal system 110. The closure door 104 may have a handle 105. The seals of this labyrinth system 120 may have a cross-sectional diameter smaller than that of the larger O-ring 112 of the barrel collar 102. Optionally, very small vent valves 130 may be installed in the door 104 to allow the venting of the area between the seals 122.

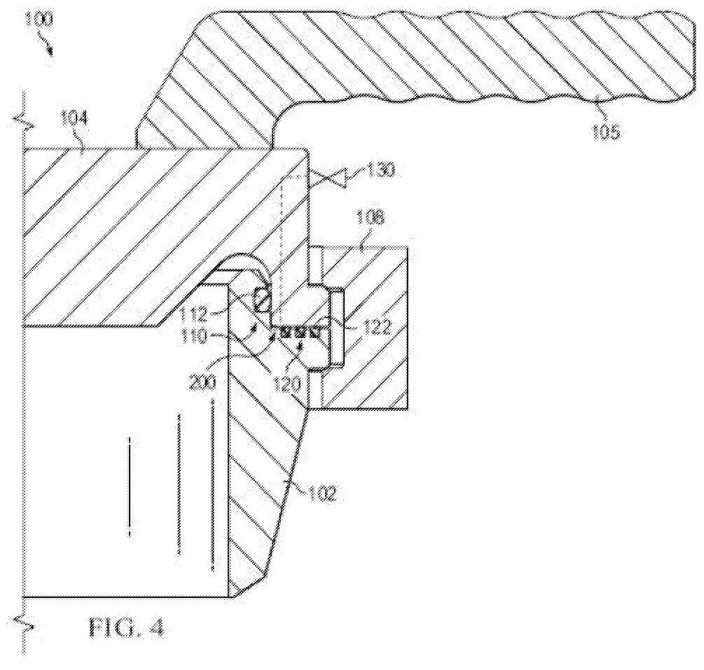

Referring now to FIG. 5, a perspective view of the closure of FIG. 3 with the barrel collar 102 exposed by the door 104 is shown. In embodiments, the primary seal 112 and the secondary seals 122 are arranged coaxial to the barrel collar 102. In methods of making the closure, grooves 114 may be made either on the barrel collar 102 or in the face of the door 104 and seals 122 placed in the grooves 114. Unlike a groove of the primary seal 112, the grooves 114 are of a compressive design.

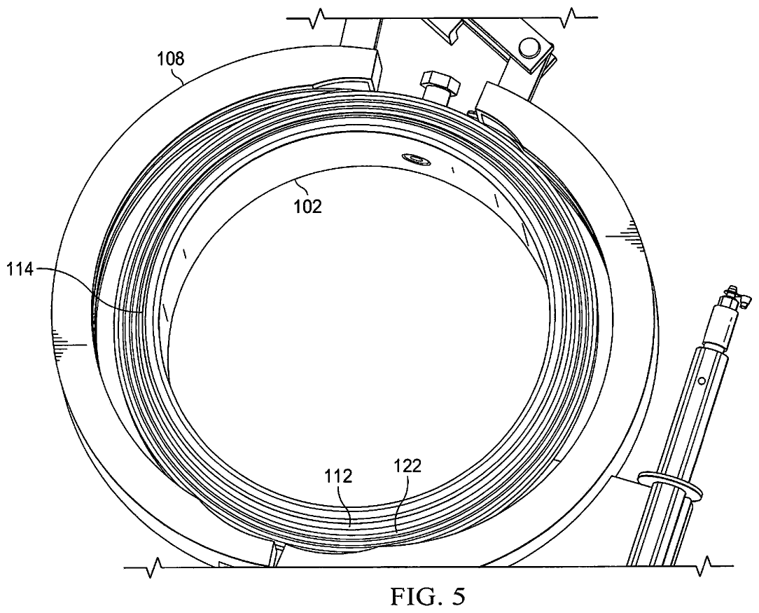

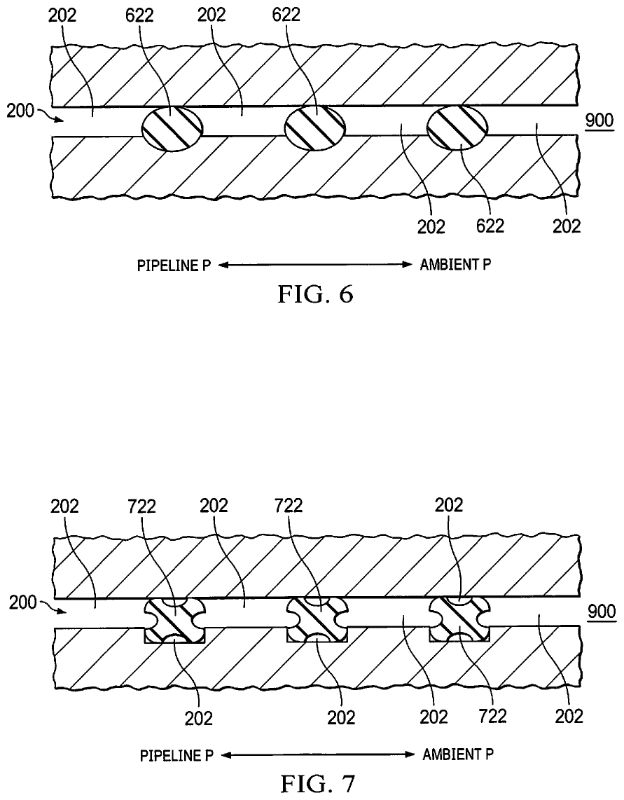

In embodiments, the seals 122 may be O-Rings, D-Rings, X-Rings, U-Rings, or some combination thereof, or their equivalents. Referring now to FIG. 6, a schematic illustrating a tortuous leak path 200 comprising a series of O-Ring 622 seals and differential pressure is shown. By way of example, each O-Ring 622 presents a single element impediment and, therefore, a single differential pressure 202. Referring now to FIG. 7, a schematic illustrating a tortuous path 200 comprising a series of X-Ring seals 722 and differential pressure 202 is shown. Each X-Ring 722 presents a double element impediment and, therefore, a double differential pressure 202 to cross over, which intensifies the tortuous path. As the number of seals 122 used for the path increases, so does the result on the sealing face 103b of the closure door 104.

Still referring to FIGS. 6 and 7, the use of the labyrinth system significantly reduces the amount of fluid or gas escape when compared to a closure door having only the primary seal 112 on the barrel collar 102. By creating a differential pressure 202 at multiple points on the face of the closure door 104, the internal fluid is not free to easily flow past only the primary seal 112 of the path 200 and then flow to the ambient environment 900 surrounding the launcher or receiver to which the closure 100 is connected. The gas (or fluid) now must pass over several seals 122 to reach the ambient pressure 900. In trying to reach ambient pressure 900, the gas must pass over these seals 122 having a differential pressure 202. The differential pressure 202 may be small, for example, below 5 psig (34.5 kpa), below 2 psig (13.8 kpa), or even about 1 psig (6.9 kpa).

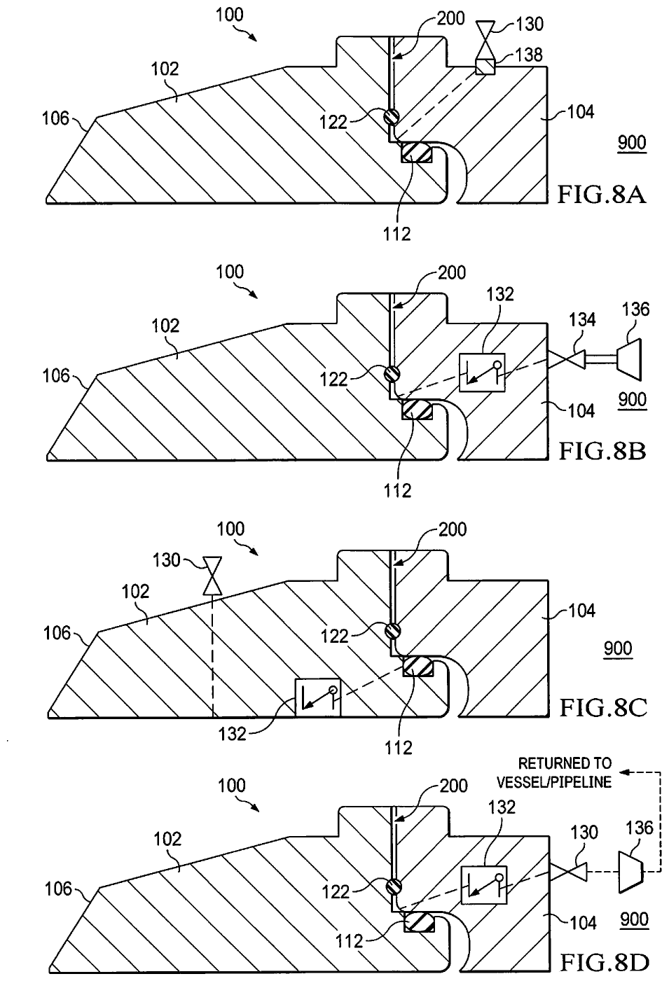

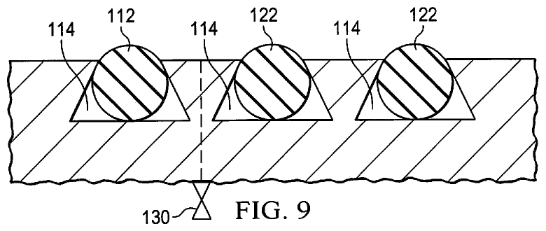

Referring now to FIG. 8A, a partial cross section perspective view of an embodiment of a closure 100 of this disclosure with a vent valve 130 is shown. In embodiments, the closure door 104 and vent valve 130 may be configured to relieve pressure from the leak path 200. The vent valve 130 and seals 122 may be configured to facilitate a double-block-and-bleed procedure (or double block and isolation) as defined by API 6D (2021; Annex E) to relieve pressure on the closure door 104 before an operator opens it. The vent valve 130 may be manually operable. The vent valve 130 may be in communication with a pressure warning lock 138 of the closure 100 or another vent or port of the closure 100.

Referring now to FIG. 8B, a partial cross section perspective view of an embodiment of a closure 100 of this disclosure with an inlet valve 134 is shown. In embodiments, the closure door 104 and inlet valve 134 may be configured to pressurize the leak path 200 between the primary seal 112 and secondary seal 122 or between seals 122 to prevent escape to ambient environment. An inert gas like nitrogen may be used. In embodiments, a vapor barrier 136 may remove moisture from gas on its way into the inlet valve 134.

Referring now to FIG. 8C, a partial cross section perspective view of an embodiment of a closure of this disclosure equipped to blow down automatically is shown. In embodiments, pressure may be vented through a vent valve 130 in the barrel collar 102 into the ambient environment 900 rather than through the closure door 104. In embodiments, the barrel collar 102 may have a check valve 132 to vent pressure from the leak path 200 to the interior of the closure 100. In an embodiment equipped with both a vent valve 130 in the barrel collar 102 and a check valve 132 from the leak path 200 to the interior of the closure 100, the leak path 200 may depressurize automatically as the closure 100 is vented.

Referring now to FIG. 8D, a partial cross section perspective view of an embodiment of a closure of this disclosure equipped to recompress leaking pipeline product is shown. In embodiments, the closure door 104 may have a vent valve 134 and a manually operated check valve 132 through which gas may be vented and returned to the pipeline. The vented gas may be passed through a vapor barrier 136 before being returned to the pipeline.

FIG. 9 is a cross sectional perspective detail of an embodiment of this disclosure with dovetail grooves. In some embodiments, the grooves 114 along the vertical sealing face 103b in the barrel 102 or the closure door 104 may be dovetail grooves or other compressive designs (for example, square groves, vee grooves, trapezoidal grooves, step grooves) to keep the seals 112, 122 in compression and protected from the impact of permeation and, consequently, from explosive decompression when blown down quickly.

The number of seals 122 in the labyrinth seal area of the closure door 104 can depend, in part, on the overall size of the closure 100, with some closures 100 being 60″ in diameter (152.4 cm). The overall design of each embodiment will depend on the mixture of the pipeline fluid as well as the aggressiveness of the sealing capacity of the closure door to minimize any effluent from the closure door 104 to the ambient environment 900.

In one particular embodiment, a hydrogen-ready primary system (O-ring seal) 110 captured about 80% of the hydrogen, and then the hydrogen-ready secondary labyrinth system 120 captured all but 1% of the rest of the hydrogen. In other words, the closure 100 captured 99.8% of the hydrogen and prevented its escape. The labyrinth impeded the hydrogen from finding a leak path 200 other than the actual downstream fluid path of the pipeline proper.

In some embodiments, the seals 112, 122 used for the primary and secondary systems 110, 120 may be made of a hydrogen reliable (hydrogen ready) material such as but not limited to fluorocarbon (“FKM”) rubber or polymers, Buna rubber (also referred to as Nitrile or Buna-N), DuPont™ Kalrez® elastomers, variable durometers, or their equivalents. In some embodiments, Buna rubber with added carbon black or its equivalent may further reduce permeability by obstructing the leak path 200 with solids. In yet other embodiments, Buna rubber that is imbued with Molybdenum, Molybdenum grease, or their equivalents may be used to seal the pores in rubber secondary seals 122 and obstruct the leak path 200.

The use of a labyrinth approach may permit the closure door to be used in vacuum applications as the door 104 will not allow air to be pulled into the launcher. This is especially important if the internal fluid is a combustible hydrocarbon. The closure door 104 may be operated safely in a vacuum process with the same safety considerations as with under positive pressure.

Embodiments of this disclosure permit a double block and bleed arrangement. For example, in some embodiments, the closure door 104 is equipped with small integral zero leak check valves 130. The valves 130 are placed inside the door 104 and allow the space between the labyrinth seal members to be evacuated independently, thereby relieving any pressure on the sealing face of the door 104 and ensuring that the forces on the door 104 are zero when opened. If the fluid inside the pipeline components contains ambient fluids that are hazardous or poisonous, such as H₂S or NH₃, additional care, other than that used with a typical closure 100, must be taken to protect personnel working around the equipment.

Embodiments of the secondary seal system 120 may be realized without affecting the general operation of the closure door 104. The closure door 104 may still operate as prior art closures, in which a launcher and or receiver is isolated, blown down, and rendered free of pressure, leaving it with an ambient charge of the fluid (gas or liquid) transported in the pipeline. Depending on the ambient contents; the closure door 104 may be opened to reload pigging equipment into the launcher or to unload from the receiver the pigging equipment and sediment brought into the receiver. When performing maintenance, the launcher or receiver may be isolated and blown down, allowing technicians to inspect sensors or gauges to ensure accuracy.

In testing conducted by the inventors, a 12-inch test vessel that was closed with a 12-inch closure modified in accordance with this disclosure (primary O-ring and tortuous path of secondary O-rings) and a 12-inch test vessel that was closed with a 12-inch standard closure (single O-ring only and no tortuous path) were each charged with 100% laboratory grade 99.999% H₂ at 1250 psig (8274 kpa) and maintained for several days. The closure door of this disclosure had a leak rate in a range of 85% to 90% less than that of the standard closure door. Any remaining losses were due to permeability, including through the metal, and leakage associated with sample points relative to sensors used for pressure and temperature measurements.

As used in this disclosure, the terms “including”, “comprising”, “consisting” and grammatical variants thereof do not preclude the addition of one or more components, features, steps, or integers or groups thereof. If the specification or claims refer to “an additional” element, that does not preclude there being more than one of the additional element. Where the claims or specification refer to “a” or “an” element, such reference is not be construed that there is only one of that element. Where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present disclosure may be implemented by performing or completing manually, automatically, or a combination thereof, selected steps or tasks. The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs. Where reference is made to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

Where a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Embodiments of this disclosure are well adapted to carry out the objects and attain the ends and advantages mentioned above as well as those inherent therein. While embodiments have been described and illustrated in relation to the drawings of this disclosure, various changes and further modifications, apart from those shown or suggested herein, may be made therein by those of ordinary skill in the art, without departing from the spirit of the inventive concept the scope of which is to be determined by the following claims.

What is claimed is:

1. A closure for pipelines carrying a fluid under pressure, the closure comprising a door, a barrel collar having a horizontal sealing face and a vertical sealing face relative to the door; and at least one clamp ring adapted to capture a circumferential portion of the door and the barrel collar when in a clamped state; the closure further comprising:
one or more seals located on the vertical sealing face, the one or more seals being circumferential and arranged to alter a path of a leak pathway between the horizontal sealing face of the barrel collar and an ambient environment outside of the door connected to the barrel collar and to cause a pressure drop across the one or more seals.

2. The closure of claim 1, further comprising the horizontal sealing face of the barrel collar including a primary seal adapted to seal the door against the barrel collar.

3. The closure of claim 2, wherein
the primary seal and the one or more seals are arranged coaxial with the barrel collar.

4. The closure of claim 3, wherein the one or more seals has a higher durometer than that of the primary seal.

5. The closure of claim 3, wherein
the one or more seals has a smaller cross-sectional diameter than the primary seal.

6. The closure of claim 3, wherein
the primary seal lies in a different plane than the one or more seals.

7. The closure of claim 3 further comprising a leak check valve arranged in the door to evacuate a volume of fluid residing between the primary seal and the one or more seals.

8. The closure of claim 1 further comprising,
a groove in either the barrel collar or the door adapted to receive a corresponding seal of the one or more seals.

9. The closure of claim 8, wherein, the groove is of a compressive design.

10. The closure of claim 1 wherein one of the one or more seals is composed of a hydrogen reliable material.

11. The closure of claim 1, further comprising a leak check valve arranged in the door to evacuate a volume of fluid trapped by the one or more seals.

12. A method for reducing an escape of fluid through a pipeline closure, the method comprising:
arranging one or more seals on a vertical sealing face of a barrel collar along a leak pathway located between a horizontal sealing face of the barrel collar and an ambient environment outside of a closure door connected to the barrel collar so that a path of an escaping fluid along the leak pathway is non-linear and a pressure drop occurs over the one or more seals.

13. The method of claim 12, wherein the fluid is of a lower molecular weight than a main fluid contained by the pipeline closure.

14. The method of claim 12, further comprising, venting a volume of fluid trapped by the one or more seals.

15. The method of claim 12, wherein the closure includes a primary seal on a horizontal sealing face of the barrel collar.

16. The method of claim 15, further comprising venting a volume of fluid trapped between the primary seal and the one or more seals.

17. The method of claim 15, further comprising, preventing an escape of a first fluid having a first molecular weight via the primary seal and preventing an escape of a second fluid having a second molecular weight lower than the first molecular weight via the one or more seals.

18. The method of claim 12, further comprising pressurizing a volume contained by the one or more seals to a pressure P2 greater than a pressure P1 contained by the pipeline closure.

19. The method of claim 16, wherein P1 is a negative pressure.
